(19) United States
(12) Patent Application Publication
(10) Pub. No.: US 2024/0006579 A1
(43) Pub. Date: Jan. 4, 2024

(54) UNIFORM LITHIUM DEPOSITION THROUGH ELECTROCHEMICAL PULSING

(71) Applicant: San Diego State University Research Foundation, San Diego, CA (US)

(72) Inventors: Kevin Wood, San Diego, CA (US); Aleksandr Aleshin, San Diego, CA (US); Kelbi Redquest, San Diego, CA (US); Jack Lucas, San Diego, CA (US)

(21) Appl. No.: 18/247,324

(22) PCT Filed: Oct. 1, 2021
(86) PCT No.: PCT/US21/53224

§ 371 Date: Mar. 30, 2023

Related U.S. Application Data
(60) Provisional application No. 63/086,513, filed on Oct. 1, 2020.

(51) Int. Cl. H01M 4/04; C25F 3/18; C25F 7/00; H01M 4/38

(52) U.S. Cl. CPC H01M 4/044; C25F 3/18; C25F 7/00; H01M 4/382

(57) ABSTRACT

In some example embodiments, there is provided example embodiments related to providing a more uniform lithium deposition based on pulsing. In some example embodiments, there is provided a method including: generating a first energy pulse followed by a second energy pulse; and applying the first energy pulse and the second energy pulse to a lithium metal electrode to electrically treat the lithium metal electrode to reduce and/or eliminate growth of dendrites on at least a portion of a surface of the lithium metal. Related systems, methods, and articles of manufacture are also disclosed.

### CROSS REFERENCE TO RELATED APPLICATIONS

This application claims the benefit of U.S. Provisional Application Ser. No. 63/086,513, titled “Uniform Lithium Deposition through Electrochemical Pulsing,” filed Oct. 1, 2020, which is incorporated herein in its entirety.

### BACKGROUND

Lithium (Li) metal electrodes have long been the holy grail of battery technology, owing to their low standard reduction potential and high gravimetric energy density. Nearly 20 years ago, research transitioned away from Li metal anodes because of severe dendrite propagation and safety concerns. However, a recent resurgence in Li metal anode research has been fueled by lithium's potential applications in Li-air batteries, Li-sulfur batteries, and Li-ion batteries (LIBs).

### SUMMARY

In some example embodiments, there is provided example embodiments related to providing a more uniform lithium deposition based on pulsing.

In some example embodiments, there is provided a method including: generating a first energy pulse followed by a second energy pulse; and applying the first energy pulse and the second energy pulse to a lithium metal electrode to electrically treat the lithium metal electrode to reduce and/or eliminate growth of dendrites on at least a portion of a surface of the lithium metal.

In some implementations, the current subject matter includes one or more of the following optional features. The first energy pulse is an oxidation pulse and the second energy pulse is a reductive pulse. The first energy pulse is an oxidation pulse and the second energy pulse is a reductive pulse. The first energy pulse and the second energy pulse form a square wave. The first energy pulse and the second energy pulse form at least one of the following waveforms: a triangle wave, a sinusoidal wave, a sawtooth wave, and a random waveform. The oxidation pulse at the lithium metal electrode passes an energy per area equal to 0.02 milliwatt-hour per centimeter squared, and an energy per area passed during the reductive pulse at an anode is at least 0.02 milliwatt-hour per centimeter squared. The first energy pulse and the second energy pulse are voltage controlled and/or current controlled. A first duration of the first energy pulse and a second of the second energy pulse each corresponds to reaching a threshold total capacity, a total energy, or a total time value. The first duration and the second duration are equal. The first duration and the second duration are different. A time gap follows the first energy pulse, and wherein the time gap precedes the second energy pulse. There may also be no time gap between the first energy pulse and the second energy pulse. Control of the first energy pulse and the second energy pulse is based on the electrical measurement between a probe in contact with the electrolyte and the lithium metal electrode being pulsed. Control of the first energy pulse and the second energy pulse is based on an electrical measurement between an electrode that completes a Galvanic cell the lithium metal electrode being pulsed. The first energy pulse and the second energy pulse are applied when the lithium metal electrode is contained in a cell of a lithium metal battery. The electrical treatment of the lithium metal electrode may improve lithium metal dissolution and/or deposition.

In some example embodiments, there is provided an apparatus for treating a lithium metal electrode to reduce and/or eliminate growth of dendrites on at least a portion of a surface of the lithium metal, the apparatus comprising: a pulse generator circuit that outputs a first energy pulse followed by a second energy pulse; and an output to enable a coupled probe to apply the first energy pulse and the second energy pulse to the lithium metal electrode to electrically treat the lithium metal electrode to reduce and/or eliminate growth of dendrites on at least the portion of a surface of the lithium metal.

In some implementations, the current subject matter includes one or more of the following optional features. The first energy pulse is an oxidation pulse and the second energy pulse is a reductive pulse. The first energy pulse is an oxidation pulse and the second energy pulse is a reductive pulse. The first energy pulse and the second energy pulse form a square wave. The first energy pulse and the second energy pulse form at least one of the following waveforms: a triangle wave, a sinusoidal wave, a sawtooth wave, and a random waveform. The oxidation pulse at the lithium metal electrode passes an energy per area equal to 0.02 milliwatt-hour per centimeter squared, and an energy per area passed during the reductive pulse at an anode is at least 0.02 milliwatt-hour per centimeter squared. The first energy pulse and the second energy pulse are voltage controlled and/or current controlled. A first duration of the first energy pulse and a second of the second energy pulse each corresponds to reaching a threshold total capacity, a total energy, or a total time value. The first duration and the second duration are equal. The first duration and the second duration are different. A time gap follows the first energy pulse, and wherein the time gap precedes the second energy pulse. Alternatively, there is no time gap between the first energy pulse and the second energy pulse. Control of the first energy pulse and the second energy pulse is based on the electrical measurement between a probe in contact with the electrolyte and the lithium metal electrode being pulsed. Control of the first energy pulse and the second energy pulse is based on an electrical measurement between an electrode that completes a Galvanic cell the lithium metal electrode being pulsed. The first energy pulse and the second energy pulse are applied when the lithium metal electrode is contained in a cell of a lithium metal battery. The electrical treatment of the lithium metal electrode improves lithium metal dissolution and/or deposition.

The details of one or more variations of the subject matter described herein are set forth in the accompanying drawings and the description below. Other features and advantages of the subject matter described herein will be apparent from the description and drawings, and from the claims. The claims that follow this disclosure are intended to define the scope of the protected subject matter.

### BRIEF DESCRIPTION OF THE DRAWINGS

FIG. 1A depicts an example of a lithium electrode being treated with at least two pulses, in accordance with some embodiments;

FIG. 1B depicts an example of a process for treating a lithium electrode with at least two pulses, in accordance with some embodiments;

FIG. 1C depicts example optical microscopy image data showing changes in the Li metal surfaces, in accordance with some embodiments;

FIG. 1D depicts examples of 2 and 3 electrode configurations, in accordance with some example embodiments;

FIG. 2 shows voltage profiles of control and pulse treated Li-metal electrodes, in accordance with some embodiments;

FIG. 3 shows electrochemical data of pulse charge matching, in accordance with some embodiments;

FIG. 4 shows a depiction of energy barriers and favorable regions present in metallic electrodeposition/dissolution, in accordance with some embodiments;

FIG. 5 shows reaction pathways correlating to electrochemical voltage profiles, in accordance with some embodiments; and

FIG. 6 shows electrochemical and optical microscopy of control and ROAR electrodes during extended cycling, in accordance with some embodiments.

### DETAILED DESCRIPTION

Next-generation batteries may require lithium-metal anodes to provide improved capacity, increased volumetric and/or gravimetric energy densities and to enable advanced cathode chemistries such as Lithium-Sulfur (Li—S) batteries and Li-air batteries. In conventional electrolytes and cycling conditions, Li-metal anodes grow sporadic and malignant volumetric structures, known as dendrites (also referred to as pits). Over time, these structures can lead to a continual electrolyte decomposition, worsening ion transport, and/or eventual failure of a Li-metal battery.

Conventional lithium-ion batteries are approaching their capacity limits and next generation batteries may be required. Most next generation and current chemistries would rely on a lithium metal anode to achieve the high energy densities desired. As noted, irreversible and volumetric growth of Li metal in electrochemical systems has long hindered practical development of a commercial rechargeable Li metal anode battery. Ultimately, this is due to the high reactivity of Li and the lack of formation of a stable and mechanical robust passivating surface that protects the electrolyte from continuous, subsequent decomposition. This problem is exacerbated, as noted, with the formation of dendrites or voluminous growths of deposited Li leading to vastly increased surface area, to more reaction sites, and to less available Li and electrolyte to be used in subsequent charge-discharge cycles. Not only does dendrite growth actively consume lithium ion (Li⁺) from the electrolyte to form lithium oxide (Li₂O), lithium carbonate (Li₂CO₃), lithium fluoride (LiF) and/or other compounds on freshly exposed Li, but the ever growing solid-electrolyte layer (SEI) can trap useful Li as well, leading to further capacity loss and reduced Coulombic efficiency (CE). For Li metal anodes to be practical in current systems, both the amount of dead Li and volumetric growth (especially in a manner that leads to drastic surface area increase) may need to be reduced if not eliminated.

While conventional lithium ion systems rely on the intercalation mechanism to shuttle lithium ions in and out of host structures, lithium metal batteries (e.g., lithium batteries with a lithium metal anode) rely on electro-deposition (or stripping) on a metal surface and are thus highly influenced by initial and subsequent surface conditions of the interacting interface. Previous methods of improving the initial surface of lithium metal for more homogenous deposition or stripping have included forming artificial SEIs, doping of solvents with additives, and mechanically modifying the lithium surface. Aside from mechanical modifications, most prior methods rely on additional components or processes being added to the system, both increasing cost and complexity. Understandably, the reactivity of the Li metal is desired for its energy storage capability but can be detrimental to its practical use. Li metal is known to exhibit a native oxide layer (NOL) that can reach tens of nanometers often composed of Li₂O, lithium hydroxide (LiOH), Li₂CO₃, and/or other compounds can spontaneously form upon contact with electrolyte.

For decades, the commercial viability of lithium metal anodes has been a challenge. An issue has been irreversible dendritic growths that create isolated and unusable Li structures, often referred to as dead Li. Over time, the accumulation of dead Li negatively affects mass transport, the electrolyte, and ultimately the safety of Li metal batteries. To address these and other issues with lithium metal batteries, disclosed herein is an in-situ process to react and homogenize the Li surface by applying (or treating) the Li metal with at least two pulses, such as energy pulses. The phrase “energy pulse” refers to a pulse. In some embodiments, the energy pulse refers to a short perturbation with the capacity for doing work. For example, the energy pulse may be a short electrochemical perturbation with the capacity for performing work on the electrode surface. In some embodiments, a combination of pulses, such as the energy pulses, is applied to the Li metal electrode in both directions using a positive going pulse followed by a negative going pulse. In some implementations, the energy pulse treatment may improve cycling performance of the Li metal electrode and a reduction (if not elimination) of traditional mossy dendrites associated with the electrodeposition of Li in carbonate-based electrolytes. And, this energy pulse treatment may be effective in both the anodic and cathodic directions.

In some embodiments, there is provided voltage pulsing of Li metal as a mechanism. This voltage pulsing treatment applied to the Li metal may prevent unwanted dendrite growth and/or improve lithium metal dissolution and deposition. This voltage pulsing may also enable uniform and/or reversible deposition of Lithium (Li) metal in a carbonate electrolyte. The voltage pulsing may change the chemical and/or structure of the Li electrode to make it more resistant to unwanted dendrite growth, for example.

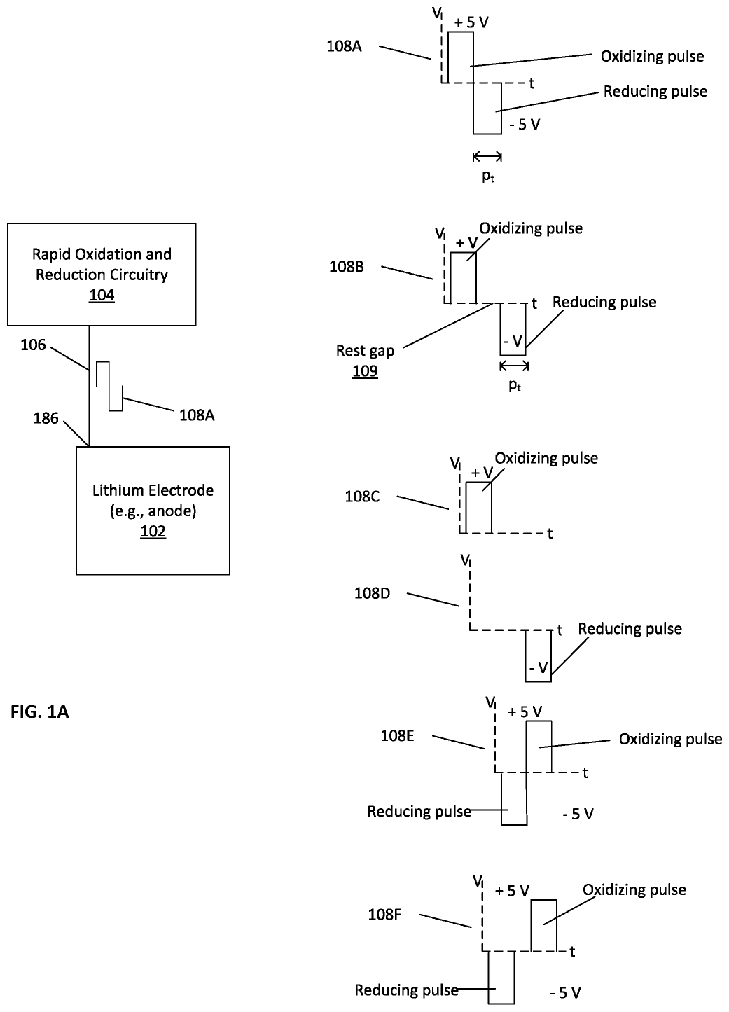

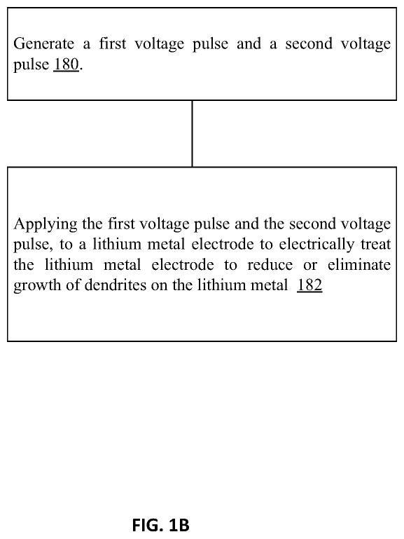

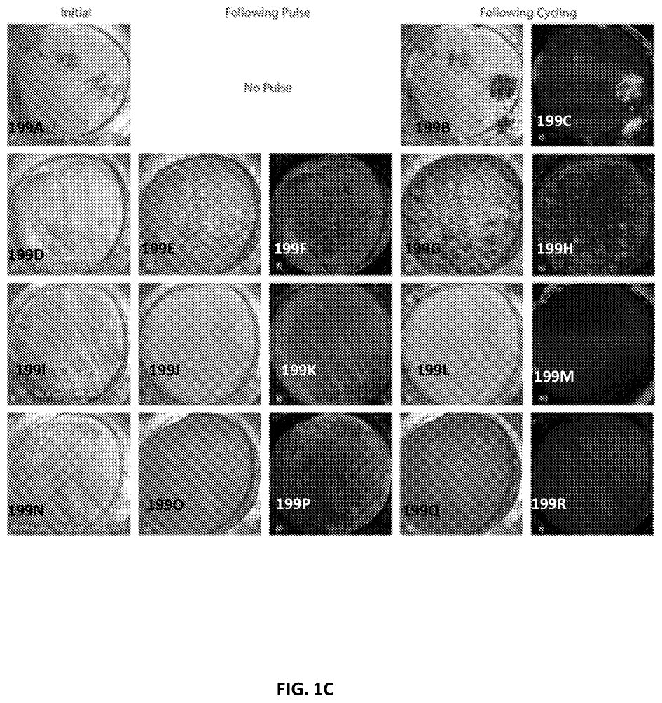

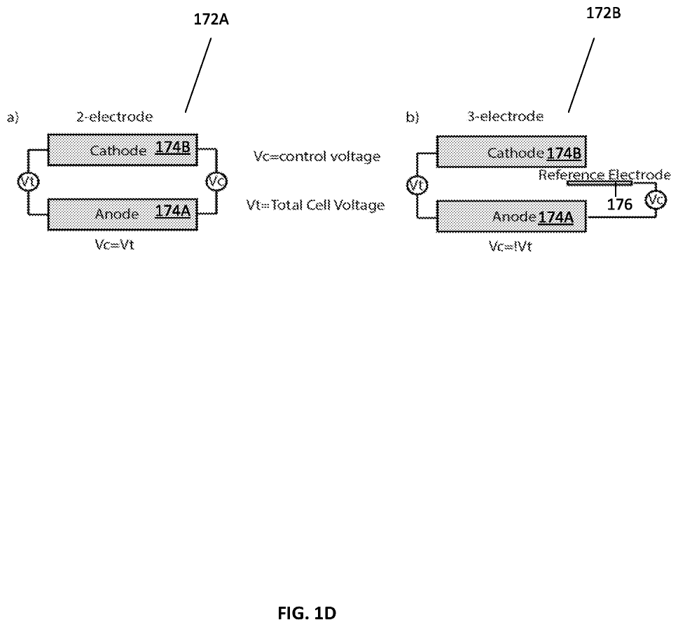

FIG. 1A depicts a block diagram of a system including a circuit 104 (labeled rapid oxidation and reduction circuitry) electrically coupled to at least one lithium metal electrode 102. The circuit 104 generates one or more pulses (e.g., energy pulses) that are applied via a 2 or 3-wire probe 106 to the lithium electrode to treat the lithium electrode. In the example of FIG. 1A, the circuit 104 may generate two pulses (e.g., energy pulses) as shown at 108A. These pulses may be output (e.g., via an output port) to the probe 106.

In some embodiments, the lithium electrode 102 is treated by applying one or more pulses, such as the energy pulses. In some example embodiments, at least two pulses 108A are applied to treat the lithium electrode 102. In some example embodiments, the first pulse is an oxidative energy pulse followed by the second pulse, which is a reductive energy pulse. These pulses are applied to treat the surface of the lithium electrode 102.

The at least two pulses 108A may be applied to the lithium electrode 102 to treat the lithium electrode (or, e.g., lithium anode) before being placed inside a battery, such as a Li-metal battery. Alternatively, or additionally, the lithium electrode may be treated while the lithium electrode (which may form an anode) is inside (or part of) an already formed battery cell. For example, a sacrificial anode (e.g., an in-situ 3-electrode) may be used to apply the at least two pulses 108A. Alternatively, or additionally, the Li metal anode may be treated by pulsing an entire cell containing the lithium anode (in-situ 2-electrode). This voltage pulsing treatment process may work in variety environments where there are Li metal (or foils) including, for example, lithium-copper (Li—Cu) laminates and Li-doped electrodes. The disclosed pulses for treating Li-metal may also be useful for other electrodeposition process, such as electro-polishing, metallization, and corrosion prevention.

In some embodiments, the circuitry 104 may generate square wave pulses as shown at 108A, for example. The square wave pulses may provide better results with respect to dendrite reduction when compared to other types of waveforms, although other types of waveforms or pulses may be used to treat the lithium electrode 102 as well. These other types of waveforms or pulses may include a triangle wave, a sinusoidal wave, sawtooth wave, a noise wave, a random waveform, and/or or other types of waveforms.

In some embodiments, the energy pulses 108A applied via a probe 106 (or other type of electrical conductor(s)) to the Li metal electrode 102 include an oxidative energy pulse followed by a reductive energy pulse. In other words, the applied energy pulse goes to a positive (+) voltage (V) before going to a negative (−) voltage. In some embodiments, the positive voltage may be +5 volts (V) and the negative voltage is −5 V as shown at FIG. 1A. However, the positive voltage may take other values as well, such as +1, +1.5, +2, +2.5, +3, +3.5, +4, +4.5, +5, +5.5, +6, +6.5, +7, +7.5, +8, +8.5, +9, +9.5, +10, +10.5, +11, +11.5, +12 and other higher voltages. And, the negative voltage may take other values as well 1, such as −1, −1.5, −2, −2.5, −3, −3.5, −4, −4.5, −5, −5.5, −6, −6.5, −7, −7.5, −8, −8.5, −9, −9.5, −10, −10.5, −11, −11.5, −12 and other higher voltages. In some implementations, higher energy pulses provided better results with respect to dendrite reduction, when compared to lower energy pulses. And, in some implementations, voltages pulses below 1 V may not improve dendrite reduction in the Li electrode 102. In some embodiments, +3 and −3V may be preferred and used advantageously for a 3-electrode configuration (an example of which is described below with respect to FIG. 1D), and +2.5V and −2.5V for a 2-electrode measurements (an example of which is described below with respect to FIG. 1D), although +5V and −5V may also provide similar outcomes with respect to dendrite reduction as well. Although specific voltages are listed, higher voltages (which do not cause unwanted side reactions between the electrode and the electrolyte such as the formation of corrosive hydrofluoric acid (HF) in the electrolyte) may be used. For example, the voltage value for a pulse may be selected by considering the effect on the counter electrode (CE) in a 2-electrode configuration.

Although FIG. 1A shows the first energy pulse and the second energy pulse reaching the same value (e.g., +5 V as a positive peak voltage and −5 V as a negative peak voltage), the first energy pulse and the second energy pulse may each have different peak voltage values (e.g., +3.5 V as a positive peak voltage and −4.5 V as a negative peak voltage).

In some embodiments, the pulse width may be 0.2 milliamp hours (mAh) per centimeter squared. The pulse width is measure between zero crossings as shown by pₜ at FIG. 1A.

In some implementations, the pulse width (also referred to as pulse length) is characterized in terms of measuring a total capacity (which reference to the amount of current multiplied by time duration of the pulse). As voltage for a given pulse may be held to a constant value for a duration of a pulse for example, so the circuitry 104 may vary a current output to 106 and electrode 102 to maintain the desired voltage. In this example, the total amount of charge that crosses the Li metal electrode-electrolyte interface may vary from run to run for different Li metal anodes, so controlling total capacity (e.g., an area under a current versus time curve) may provide control and reproducibility. This may also indicate that the positive pulse and the negative pulse may have different durations. In other words, the oxidative energy pulse and the reductive energy pulse may have different pulse lengths (or widths) but the oxidative energy pulse and the reductive energy pulse can still have the same total capacity. Although some of the examples refer to having the same total capacity in the positive pulse and the negative pulse, the positive and negative pulses may have different total capacities.

Alternatively, or additionally, the current for a given pulse may be held to a constant value for a duration of a pulse for example, so the circuitry 104 may vary a voltage output to 106 and electrode 102 to maintain the desired current.

In some embodiments, the positive portion of pulse 106 is referred to as the “oxidizing pulse” (or oxidation pulse) and the negative portion of the pulse is referred to as the “reducing pulse” (or reduction pulse).

In some embodiments, a gap 109 (labeled rest gap) at pulses 108B of FIG. 1A may be used between the pulses. In some embodiments, the gap 109 may between 30 sec-5 min. In some implementations, having no gap between the energy pulses may provide better results.

In some embodiments, the gap 109 may be omitted as shown at 108A. In some implementations, it may be advantageous to remove the gap 109 to provide improvement in performance with respect to dendrite reduction.

In some embodiments, only a single positive pulse 108C or a single negative pulse 108D is used to treat the Li electrode. However, the use of at least two pulses and/or a positive pulse followed by a negative pulse may, as noted, improve the treatment of the Li electrode surface to reduce the likelihood of dendrite growth or other unwanted structures. In some experiments, there was an improvement in dendrite reduction, when 3 pulses were used instead of 2 pulses. While using more than 3 pulses may improve uniformity on future deposition/dissolution cycles, the use of more than 3 pulses may result in a detachment of lithium from the electrode's surface. This is undesirable and would reduce the working capacity of a battery. For some applications, this detachment may, however, be an acceptable outcome, in which case more than 3 pulses may be used.

FIG. 1A also shows pulses 108E, which is similar to pulse 108A but a negative pulse (reducing pulse) is applied to the Li electrode before the positive pulse (oxidizing pulse) is applied. Pulses 108F, which is similar to pulse 108E but includes a rest gap.

Although some of the examples refer to applying two pulses to the Li electrodes to treat the electrode surface, other quantities of pulses may be applied as well (e.g., 3, 4, or other quantities).

After the lithium electrode is treated by applying at least two pulses such as the pulses 108A, the Li electrode 102 may undergo a chemical and/or a structural change which may improve the lithium electrodes ability to prevent the growth of dendrites and/or other growths after being cycled (e.g., during discharging and charging of a Li based battery such as Li-metal battery).

FIG. 1B depicts an example process for treating a lithium electrode with at least two pulses, in accordance with some embodiments

At 180, a first energy pulse and a second energy pulse are generated. For example, circuitry 104 may generate a first pulse followed by a second pulse. The first and second pulses may be square waves as shown with respect to pulse 108A, B, E, or F, although other types of waveforms may be applied as well. In some embodiments, the first pulse is applied as a oxidative energy pulse (e.g., an oxidizing pulse) followed by a negative pulse (e.g., a reducing pulse). Oxidation as used herein refers to an electrode losing electrons, and reduction as used herein refers to when an electrode gains electrode. The first pulse may reach a positive voltage threshold, such as +5 V as shown at 108A, while the second pulse may reach a negative voltage threshold, such as −5 V as shown at 108A, although other voltage values may be implemented as noted above. In some implementations, each pulse may deliver 0.5 mW/cm2, 0.1 mW/cm², 0.05 mW/cm², 0.01 mW/cm², 0.005 mW/cm² watts of power, for example. In some implementations, the pulse width may be determined based on the capacity, such as 0.2 mAh/cm², 0.15 mAh/cm², 0.1 mAh/cm², 0.05 mAh/cm² for example. In some embodiments, the first energy pulse is separated in time from the second energy pulse by a rest gap 109, although the gap 109 may be omitted as well. In some embodiments, the circuitry controls the current and/or the voltage to deliver a predetermined (or threshold) amount of capacity to the Li metal electrode 102.

At 182, the generated first pulse and the second pulse are applied to the Li metal. For example, the first energy pulse and the second energy pulse 108A are applied via a probe 106 to the surface of the Li metal 102, which is being used as an electrode or anode of a Li-based battery, such as a Li-metal battery. In some embodiments, only two energy pulses need to be applied to treat the Li-metal to induce a change to the Li-metal (e.g., a structural change) that makes the Li-metal more resistant to dendrites and/or other structural issues. However, additional energy pulses may be applied as well.

After the generated pulses are applied, the Li-metal (which is part of a battery) may be cycled (e.g., charged and discharged). However, the “electrically” treated (i.e., with the at least two pulses) Li-metal of the battery is less likely to have dendrites, when compared to a Li-metal in a battery that has not been electrical treated.

As noted, the Li-metal treatment of 180-182 may be performed on the Li-metal before it is inserted into a battery or while it is contained in a cell or battery.

Although some of the examples refer to Li-metal batteries, the disclosed pulses may be applicable to other areas utilizing electrochemical metal-ion deposition.

FIG. 1D depicts an example of the Li-metal anode treatment performed in a 2-electrode battery cell 172A or 3-electrode battery cell 172B configuration. In the two electrode 172A example, the voltage created by the potential difference between the anode 174A and the cathode 174B is held to a constant voltage (Vc=Vt). In this 2-electrode 172A example, the total voltage Vt of the cell is the voltage that is controlled and thus is applied the energy pulses to treat the anode 174A, such as the Li-metal anode. In the 3 electrode 172B, the voltage (Vc) created between the anode 174A and a non-reacting, constant potential (or reference) electrode 176 controls the application of the pulses. In the case of the 3 electrode cell, the control voltage (Vc) and the total voltage (VT) of the cell will have different values. To illustrate further, another electrode such as reference electrode 176 may be used. When this is the case, voltage control and/or current control the first energy pulse and/or the second energy pulse may be based on an electrical measurement between the reference electrode 176, which completes a Galvanic cell with the lithium metal electrode being pulsed (which in this example is anode 174A) with the first and second pulses.

Referring again to FIG. 1A, the circuitry 104 may include a pulse generator that outputs 186 the first energy pulse followed by a second energy pulse as shown at 108A, for example. This output 186 (including the first and second pulses) can be provided to the probe 106 to treat at least a portion of the Li-metal electrode, such as a Li-metal anode 102. Moreover, the circuitry 104 may include control circuitry to measure or monitor the capacity delivered per pulse. For example, first pulse may be controlled such that at the lithium metal electrode passes an energy per area equal to 0.02 milliwatt-hour per centimeter squared is applied. Alternatively, or additionally, an energy per area passed during the reductive pulse at an anode may be controlled to deliver at least 0.02 milliwatt-hour per centimeter squared, for example. In some embodiments, the circuitry 104 includes a waveform generator to generate specific waveforms. Alternatively, or additionally, the circuitry 104 may include circuitry (e.g., a voltage controlled current source, voltage regulators, current regulators, variable voltage sources, and/or variable current sources) to control the delivery of current and/or voltage during the application of the pulses. In this way, the first pulse may be controlled such that it is applied until a threshold total capacity, a total energy, or a total time value is reached.

### ADDITIONAL EXAMPLES

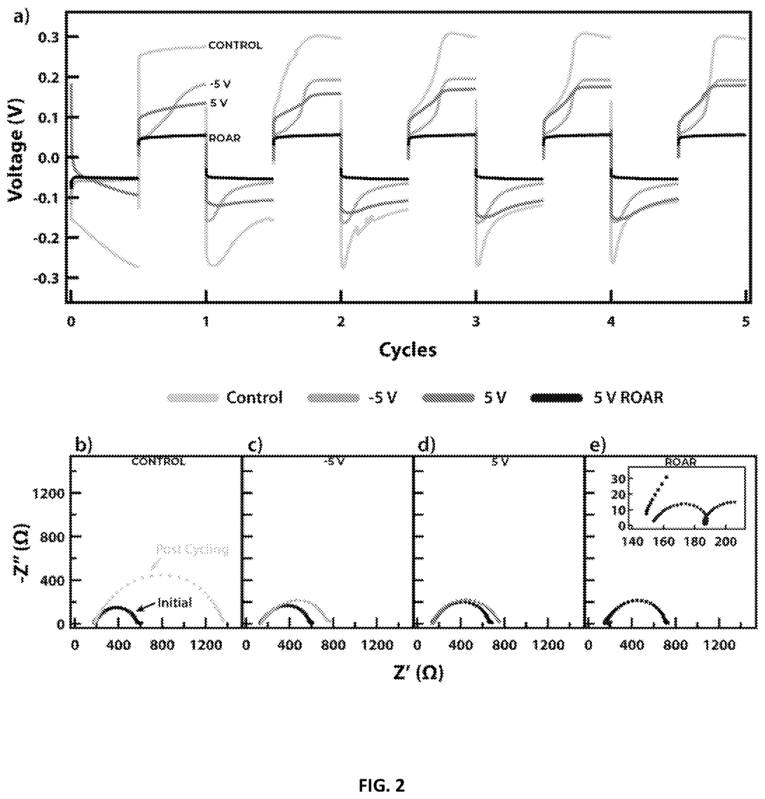

FIG. 2 shows an example of electrochemical data. FIG. 2 at (a) shows voltage profiles of control and pulse treated electrodes cycled at 1 mA cm⁻². The EIS measurements of control and pulse treated Li electrodes before and after cycling for (b) an untreated control electrode, (c) an electrode treated with a single −5 V pulse, (d) an electrode treated with a single +5 V pulse, and (e) an electrode treated with a positive 5V pulse followed by a negative 5 volt pulse (labeled ROAR) treatment.

As a control for purposes of comparison, Li metal was first cycled at 1 mA cm⁻² for 5 cycles of 5-minute half cycles of charging and discharging. As the Li metal was not treated as described with respect to FIG. 1A with the pulses, the Li metal exhibited characteristic dendrite growth in sparse regions. FIG. 1C at 199A shows the untreated surface of the Li metal before cycling, and 199B-C show the dendrite growth. With subsequent stripping, voltage profiles as shown at FIG. 2 at (a) show the transition from dendrite dissolution to bulk dissolution evident from the characteristic peaking behavior and darkening of originally silver dendrites. It has been shown the presence of voltage peaks in constant current cycling corresponds to a transition from dissolution from dendrites to the bulk lithium.

The Li-metal is then applied a treatment of a 6-second energy pulse. Next, the treated Li-metal is cycled at 1 mA cm⁻² constant current with deposition first. A reductive energy pulse addresses the rapid deposition of lithium onto the working electrode (WE), while a positive pulse addresses the rapid dissolution of lithium from the working electrode. In-situ optical imaging 199D-M shows with both the impact of a oxidative energy pulse (199I-M) and reductive energy pulse (199D-H), and in particular shows that more of the surface is initially active and the voltage profile of cycling changes from peaks to more leveled cycling. However, with negative pulsing (as shown at FIG. 1C at 199D-H) larger dendritic features still grow after cycling as shown at FIG. 1C at 199G, albeit more uniformly and to a smaller size than control dendrites. Positive pulsing (as shown at FIG. 1C at 199I-M), however shows little growth on the face after cycling but some growth under the polypropylene ring used to press the electrode onto the current collector.

In accordance with some embodiments, the Li-metal was treated with at least two pulses, such as pulses 108A for example. For example, the Li-metal was treated with a oxidative energy pulse directly followed by a reductive energy pulse. FIG. 1C at 199N-R shows examples of the results. Specifically, FIG. 1C at 199N-R show the effects of rapid dissolution (thought to increase the local electrolyte concentration and expose fresh lithium) with rapid deposition to form high surface area lithium structures for subsequent cycling. In some embodiments, the combination of pulses may improve the voltage profile as shown at FIG. 2 at a (5V ROAR plot) and prevent the growth of large dendritic structures after standard cycling (see, e.g., FIG. 1C at 199N-R).

Electrochemical impedance spectroscopy (EIS) may provide insight into changes of the surface or interface of the Li metal electrode. Final EIS measurements were taken after rest following the final dissolution cycle. For the control case of an untreated Li electrode as noted with respect to FIG. 1C 199A-C, FIG. 2 at (b), the R_{CT}, correlates with the width of the semicircle, increased by around 3 fold likely due to an ever increasing SEI and the lack of available lithium in the more reactive dendrites that did form. EIS following cycling for both pulses FIG. 2 at (c) and (d) show a substantial decrease in both the R_{CT} and CDL compared to the control. The EIS for the negative pulse, FIG. 2 at (d), suggests the formation of a second interface layer, evident by the increased linearity in high frequencies that may correspond to an additional diffusive or reactive pathway. The combination of positive and negative pulses further decreases the charge transfer resistance (R_{CT}) and double layer capacitance (CDL) and introduces a second pronounced semicircle as shown at FIG. 2 at (e). Additionally, a so-called inductive loop (or negative capacitance) appears in lower frequencies. This may be attributed to corrosion or drift and may suggest the formation of reactive species at higher voltages, which continue to etch the surface after cycling.

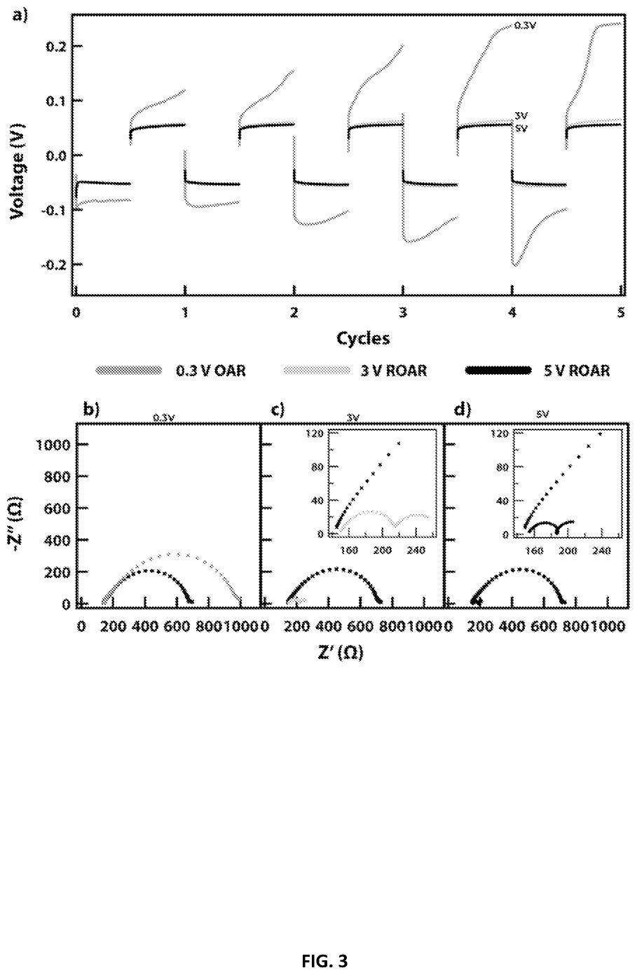

FIG. 3 shows electrochemical data of pulse charge matching (e.g., Q=0.050 mAh). FIG. 3 at (a) shows voltage profiles for charge matched pulsing and cycling. FIG. 3 at (b) shows EIS spectra of 0.3 V OAR. FIG. 3 at (c) shows EIS spectra for 3 V ROAR treated electrode. FIG. 3 at (d) shows EIS spectra for 5 V ROAR treated electrode. FIG. 3 at (e) shows post-cycling image of 0.3 V ROAR, FIG. 3 at (f) shows 3 V ROAR, and FIG. 3 at (g) shows 5V ROAR.

To further understand the underlying mechanism of the voltage pulsing disclosed herein as opposed to a control metal electrode, the disclosed voltage pulsing technique was attempted at lower voltage magnitudes of 0.3 V and 3 V. In the control Li electrode of FIG. 1C at 199A-C, a rough maximum voltage experienced is 0.3 V and pulses of ±5 V for 6 seconds pass roughly 0.050 mAh of charge per pulse, so a new “control” was “pulsed” for 0.3 V until 0.050 mAh charge passed then pulsed at −0.3 V for the same charge passed and similarly repeated for ±3 V on a new electrode. For ±0.3 V, large dendrites form during the negative pulse but initial cycles seem promising before peaking behavior returns as seen in FIG. 3 at (a). Next, the same concept was applied for ±3 V pulses resulting in an almost identical response to the ±5 V pulse treatments as shown at FIG. 3 at (a). EIS spectra before and after cycling for the ±0.3 V pulses as shown at FIG. 3 at (b) shows a similar trend although to a lower degree suggesting more charge passed in initial cycles may provide some benefit to initial cycling. Comparing EIS for the 3 V and 5 V cases, FIG. 3 (c)-(f) show similar spectra with the 3 V lacking the low frequency loop seen previously in the 5 V suggesting no formation of corroding species.

The application of a voltage to the Li electrode (or metal) beyond what is normally experienced or advised may provide several benefits including one or more of the following: (1) increasing the active area of the lithium electrode allowing more homogeneous reactions across the surface via reduced local current density, (2) rapidly dissolving the thicker native oxide layer (NOL) and SEI, and (3) creating a more macroscopically uniform, electrically and ionically active surface for subsequent cycling.

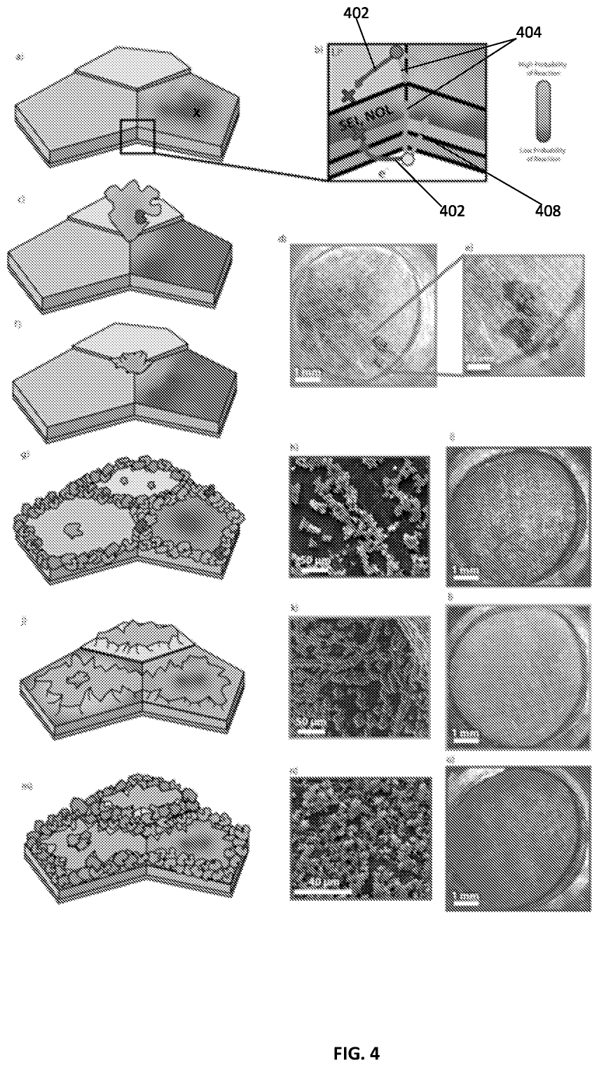

FIG. 4 at (a) depicts energy barriers and favorable regions present in metallic electrodeposition/dissolution. FIG. 4 at (b) shows the proposed inclination of electrons and Li ions (404 arrow indicates preferred path along grain boundaries, 408 arrow indicates higher resistance trajectory through SEI and NOL components, lines 402 indicates improbable and high resistance trajectory). The low induced voltage deposition leading to dendrite growth is shown at FIG. 4 at (c). FIG. 4 at (d) shows the 0.3 V pulse dendrite growth. FIG. 4 at (e) shows dead lithium (dark region) on the same dendrite following cycling. FIG. 4 at (f) shows a low induced voltage dissolution leading to “pit” growth. FIG. 4 at (g) shows a high-induced voltage deposition leading to increased deposition and “activation” of regions above normal threshold. FIG. 4 at (h) shows a SEM image of deposits from −5V pulse. FIG. 4 at (I) shows an optical image of electrode following −5V pulse, most of the surface is coated in Li deposit. FIG. 4 at (j) shows a high-induced voltage dissolution leading to increased stripping and “activation” of regions above normal threshold. FIG. 4 at (k) shows a SEM image of dissolution “canyons” from 5V pulse. FIG. 4 at (1) shows an optical image of electrode following 5V pulse, again most of the surface has reacted (1). FIG. 4 at (m) shows the combination of high-induced positive and negative voltages leading to increased dissolution and deposition. FIG. 4 at (n) shows a SEM image of combined 5V and −5V pulse showing drastically increased surface area. And, FIG. 4 at (o) shows an optical image of electrode following dual pulse.

The surface of as-received lithium metal is typically not uniform, so it makes sense to think of how this non-uniformity effects electrodeposition and electro-dissolution. Even optically, grains and deformations or defects from manufacturing and handling are usually visible on the surface of Li and these can facilitate ion and electron transport in the SEI. If the electrode is viewed as a collection of individual crystals (see, e.g., FIG. 4 at (a) and (b)) it intuitively makes sense that higher energy and more electrically and ionically conductive regions, like grain boundaries or step and defect sites, will have a higher probability of participating in either dissolution or deposition of Li due to increased electron and ion transport in these regions. Therefore, a consequence of demanding a low current or voltage is that less regions are available to either drive electrons to the surface or pull electrons to the current collector reducing the homogeneity of reaction along the surface.

In some implementations, a current density of 1 mA cm′ resulted in an average voltage of 0.3V and if a fresh Li-electrode was held at a voltage of −0.3 V for the same charge passed as a 5V, 6 second pulse (0.05 mAh), the dendritic growths seen in FIG. 4 at (d) and (e) grew even after stripping at 0.3 V for the same charge at 5V. These dendrites are often weakly attached and will separate from the electrode during cycling suggesting a very small region of growth on the actual electrode and more growth from the now less resistive dendrite surface. This all supports that as-received lithium metal inherently consists of regions that will not react at standard and even higher voltages than most conventional forming cycles and itself may be the cause of dendritic growth early on in cycling.

As the magnitude of the voltage imposed increases, it can be expected that more of the surface will become “active” in that electrons are able to reach or leave the surface in more locations and at a faster rate resulting in more homogeneous morphologies across the electrode surface. In the case of negative pulses, more electrons can reach the surface to interact with Li ions before the growth of singular large dendrites occurs that leads to run away, preferential growth on these monolithic structures. Rather, growth occurs more uniformly on the surface (FIG. 4 at (g)-(i)) with SEM images confirming that, for a −5V, 6 second pulse, mechanically and electrically attached growths remain even after rinsing the electrode in dimethyl carbonate. More uniform initial growth makes the runaway effect, where the growth of a dendrite makes the dendrite the least resistive path for reaction and thus prevents the surrounding region from reacting, less likely due to a decreased path length from the electrolyte to a now active surface.

For the 5V, 6 second pulse, the SEM images show the formation of deep, fractal like “canyons” along the surface exposing fresh Li (FIG. 4 at (j)-(i). The surface area of the canyon features appears to be much smaller than the growths in the negative pulse possibly explaining why the negative pulse has slightly better performance. The overall, bulk linear patterning of these canyon features suggests preferential dissolution from mechanically induced features such slip lines, as seen in other work. Deviations, with more angular patterns, seem to correlate with apparent grain boundaries visible in optical images and observed in other work. Smaller, individual pits beyond these valleys can however nucleate in these lines and propagate, suggesting certain conditions are favorable for initial and homogenous dissolution.

Finally, combining the 5 V and −5 V pulses results in a thick, uniform growth of Li structures along the surface (FIG. 4 at (m)-(o)). In all the higher voltage cases, both the surface area and homogeneity are vastly increased compared to the untreated surfaces, serving to both decrease the effective current density and the average path length to an active and non-resistive surface for following cycling.

Dissolution of Li metal into a Li⁺ ion is thermodynamically favorable, but the physical process of removing a Li atom from its lattice is non-negligible and it is far more likely a less coordinated Li atom (such as an adatom or step atom) dissolves before a fully coordinated planar atom. This is likely why defect sites and boundaries preferentially dissolve opposed to the entire surface and typically stripping requires a higher voltage than deposition. At mismatched and disordered regions Li metal atoms are less coordinated and the barrier to dissolution is reduced. With conventional graphite anodes, the composition of various particle sizes, interfaces, and orientations makes the electrode, overall, more uniform by removing drastic local heterogeneities. Lithium metal often comes with microsized, visible grains that have been seen largely not to react and lead to sporadic dendrites along more energetically active regions like grain boundaries and extrusion lines. Restriction to reaction along a planar surface exacerbates this problem by requiring Li⁺ ions located in inactive regions, such as the center of a crystal, to migrate to higher activity region. This is visualized by FIG. 4 (a) where regions labeled “x” are less likely to react so ions in this region must migrate, either through the electrolyte or along the surface to more reactive zones. This may explain why surface coatings of LiF improve cyclability, by providing a faster diffusion along the surface.

This disconnect between deposition and migration time scale is believed to cause dendritic growth. SEI or surface modifications, such as higher LiF content, likely improve this disconnect by resulting in higher surface diffusion of Li but still do not prevent runaway growth. With more nucleation sites becoming active from pulsing, it is safe to assume less over potential for deposition and shorter length and time scales for Li ion transport before contacting an energetically favorable and electronically active surface will lead to lower dendritic growth compared to untreated electrodes.

Another possible explanation for increased performance may lie in the interaction of the SEI at higher than normal voltages. Inorganic SEI components like Li₂O, LiOH, Li₂CO₃, and LiF are typically electrical insulators and at lower voltages it is unlikely for these components to participate in oxidation reduction reactions of the battery. Regions of thicker, more insulating SEI may correspond to low electron transport in conventional cycling leading to heterogeneous dendrite formations in the most conducting regions of the electrode, such as grain boundaries or thinner SEI regions. However, with higher potential applications, regions previously inaccessible to deposition or dissolution may be “activated.” Theoretically, at high enough potential the SEI itself should conduct electrons and the direct reduction of the SEI into lithium metal and byproducts can lead to a rearrangement of the SEI which leads to subsequent improved cycling.

Complexity of the system and processes at play makes a single, definite explanation highly unlikely and will be the continuing focus of future works. The combination of treatments are likely required to effectively form a suitable surface for Li reactions. Rapid dissolution of typical inactive regions both leads to increased active area and subsequently reduced local current density and increased local Li⁺ concentration that can be used for following deposition. Likewise, deposition in multiple regions decreases the path length to new, active surfaces decreasing mass transfer limitations and reduces effective current density. Long term cyclability and electrolyte stability are also key concerns that will be researched further. Ultimately, voltage pulsing may provide substantial chemical and topographical benefits to the surface of lithium metal which in turn result in better electrochemical performance and repeatability of cycling for future experiments.

Thus, there is disclosed herein voltage pulsing Li metal far-from-equilibrium on electrochemical performance, surface morphology, and chemical composition as a potential mechanism to both prevent unwanted dendrite growth and improve lithium metal dissolution and deposition.

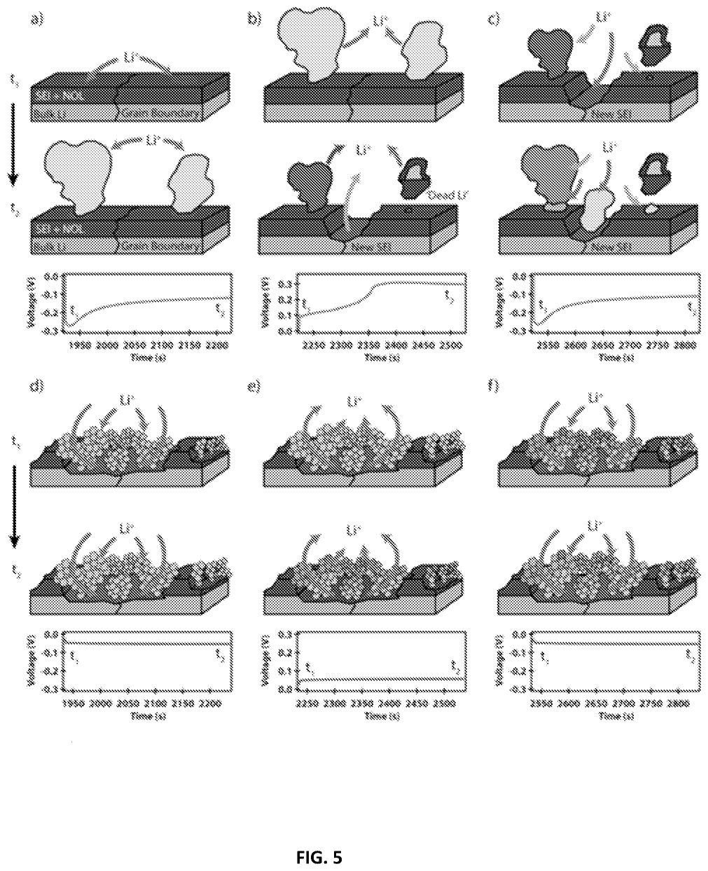

FIG. 5 shows an example of a reaction pathways that correlates to electrochemical voltage profiles. At FIG. 5, at (a), the deposition on the untreated electrode is shown. The hot-spots lead to dendrite nucleation and reduction in voltage required for subsequent deposition. FIG. 5 at (b) the dissolution pathway is initially from dendrites but transitions to the higher impedance bulk once dendrites are depleted, evident by increase in voltage. FIG. 5 at (c) shows subsequent deposition pathway prefers newly formed pits and grow new dendrites. FIG. 5 at (d) shows deposition on ROAR treated electrode surface. A variety of high surface area features leads to uniform reaction pathway and leveled voltage. FIG. 5 at (e) shows dissolution likewise follows uniform reaction pathway and little to no dead Li is formed. And, FIG. 5 at (f) shows deposition on non-depleted structures leads to uniform reaction pathway.

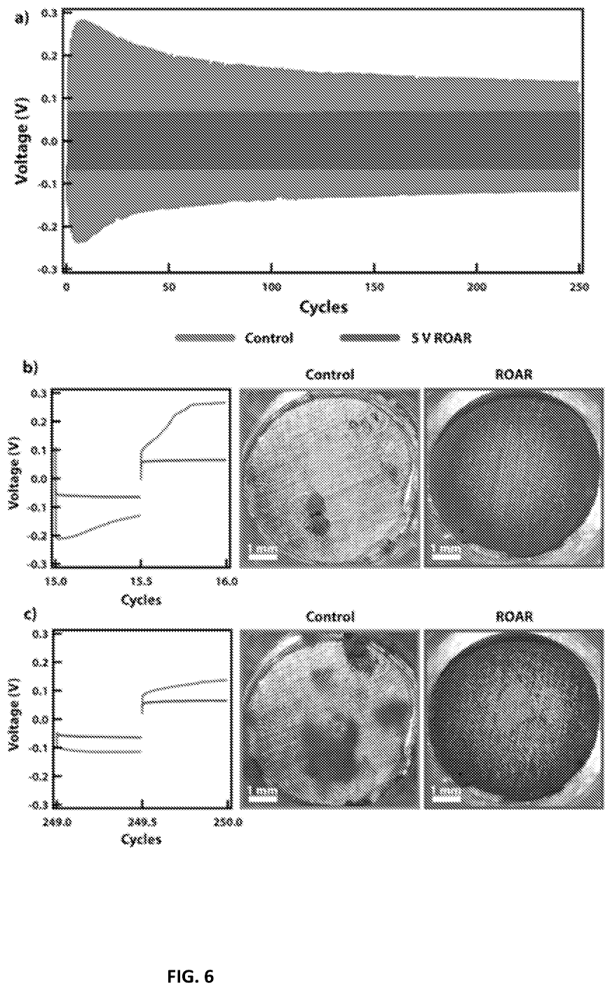

FIG. 6 shows examples of electrochemical and optical microscopy of control and ROAR electrodes during extended cycling. FIG. 6 at (a) shows voltage profiles of control and ROAR electrodes. FIG. 6 at (b) shows electrochemical data and optical images after 15 cycles. And, FIG. 6 at (c) shows it after 250 cycles. Detached dendrites float to the top of the cell in the control.

The electrical treatment of the Li metal may be referred to as a Rapid Oxidation and Reduction (ROAR) treatment. For the ROAR treatment, the initial application of an oxidative pulse serves to both activate/equalize dissolution sites (assuming an increase in the local electrolyte concentration at the surface). The reductive pulse rapidly deposits mechanically robust and high surface area structures in both the canyons and across the surface. Now that both dissolution and deposition sites have been activated/equalized, during cycling these newly created sites have similar reaction pathway impedances and are vastly more homogeneous than the native surface. This may result in 1) a reduction of local current density and 2) a prevention of reaction pathway transitions. This may be seen via optical microscopy images and evident by the flat voltage profile and lack of peaking observed in the electrochemical data as shown at FIG. 5 at (d)-(f). Since there is a mixing of reaction pathways between features, most dendrites are less likely to be depleted and become detached from the surface. This prevents the buildup of large dead Li structures, which has been shown to lead to cell failure. After 250 cycles, the ROAR treated electrode exhibited almost identical electrochemical performance to that of early cycles with little to no variation during extended cycling (see, e.g., FIG. 6 at (a)). Likewise, the entire surface may be seen to continually and uniformly participate in cycling with no loss of material, while the control exhibited characteristic ‘mossy dendrites’ which became detached (see, e.g., FIG. 6 at (b)-(c)). Additionally, data from higher areal capacity cycling (1 mAh cm⁻² vs. 0.083 mAh cm⁻²) shows the ROAR treated electrodes maintain homogeneity and prevent the formation of ‘mossy dendrites’. In the electrochemical response the control exhibits the characteristic peaking' behavior however the ROAR treated electrode voltage response may still remain smooth and flat. Moreover, to show the benefit of the ROAR treatment is not just the addition of initial Li, a long oxidation half cycle was tested. In this test, a long oxidation' half cycle which stripped 2.3 times the areal capacity that was deposited during the ROAR treatment and initial deposition half cycle did not cause mossy dendrites or peaking behavior in subsequent standard cycling.

Since regions on the surface have different impedances for dissolution/deposition reactions, the percent activation of the surface should be related to the voltage applied. And, cycling after the low voltage OAR (0.3 V) (see, e.g., FIG. 3 at (a)-(b)) produces large mossy dendrites even after pulsing the same amount of charge as the ROAR. This poor performance can be explained by the lack of adequate voltage initially applied to activate a large number of sites across the surface. This indicates that the traditional low current, low C-rate formation cycles for conventional electrodes may not be advantageous for Li metal anodes and may itself lead to unstable growth of dendrites and pits.

By increasing the magnitude of the pulses, to 3 and 5 V, the electrochemical performance is improved (peaking is prevented and over potential is decreased) and the majority of the surface is seen to react in the optical images. We hypothesize that part of the reason high voltage treatments are effective is because they fundamentally change the SEI, either mechanically and/or chemically. At low voltages, it is extremely unlikely for Li ions to traverse through a majority of the SEI present on the surface at a sufficient rate before low impedance sites have reacted and led to runaway growth. By applying higher voltage, we can force ions through the SEI, rapidly forming deposits, leading to cracking and pulverization. This removes high impedance barriers to Li-ion deposition and dissolution in more locations by producing fresh Li surfaces for subsequent cycles. Likewise, at high enough potential the SEI itself may participate in oxidation/reduction reactions, decreasing the thickness and/or changing its chemical composition. The only major observed difference between the 3 and 5 V ROAR treatments is the missing loop in the EIS spectra of the 3 V ROAR. This may suggest there is a chemical change from corrosion or side reactions occurring due to the 5 V ROAR, however this loop may also indicate improved surface diffusion or be an instrumental artifact owing to decreased impedance. More studies are needed to better understand the mechanisms of ROAR pulsing on Li metal.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
generating a first energy pulse followed by a second energy pulse; and
applying the first energy pulse and the second energy pulse to a lithium metal electrode to electrically treat the lithium metal electrode to reduce and/or eliminate growth of dendrites on at least a portion of a surface of the lithium metal.

2. The method of claim 1, wherein the first energy pulse is an oxidation pulse and the second energy pulse is a reductive pulse.

3. The method of claim 1, wherein the first energy pulse is an oxidation pulse and the second energy pulse is a reductive pulse.

4. The method of claim 2, wherein the first energy pulse and the second energy pulse form a square wave.

5. The method of claim 1, wherein the first energy pulse and the second energy pulse form at least one of the following waveforms: a triangle wave, a sinusoidal wave, a sawtooth wave, and a random waveform.

6. The method of claim 2, wherein the oxidation pulse at the lithium metal electrode passes an energy per area equal to 0.02 milliwatt-hour per centimeter squared, and an energy per area passed during the reductive pulse at an anode is at least 0.02 milliwatt-hour per centimeter squared.

7. The method of claim 1, wherein the first energy pulse and the second energy pulse are voltage controlled and/or current controlled.

8. The method of claim 7, wherein a first duration of the first energy pulse and a second of the second energy pulse each corresponds to reaching a threshold total capacity, a total energy, or a total time value.

9. The method of claim 7, wherein the first duration and the second duration are equal.

10. The method of claim 7, wherein the first duration and the second duration are different.

11. The method of claim 1, wherein a time gap follows the first energy pulse, and wherein the time gap precedes the second energy pulse.

12. The method of claim 1, wherein there is no time gap between the first energy pulse and the second energy pulse.

13. The method of claim 1, wherein control of the first energy pulse and the second energy pulse is based on the electrical measurement between a probe in contact with the electrolyte and the lithium metal electrode being pulsed.

14. The method of claim 1, wherein control of the first energy pulse and the second energy pulse is based on an electrical measurement between an electrode that completes a Galvanic cell the lithium metal electrode being pulsed.

15. The method of claim 1, wherein the first energy pulse and the second energy pulse are applied when the lithium metal electrode is contained in a cell of a lithium metal battery.

16. The method of claim 1, wherein the electrical treatment of the lithium metal electrode improves lithium metal dissolution and/or deposition.

17. An apparatus for treating a lithium metal electrode to reduce and/or eliminate growth of dendrites on at least a portion of a surface of the lithium metal, the apparatus comprising:
a pulse generator circuit that outputs a first energy pulse followed by a second energy pulse; and
an output to enable a coupled probe to apply the first energy pulse and the second energy pulse to the lithium metal electrode to electrically treat the lithium metal electrode to reduce and/or eliminate growth of dendrites on at least the portion of a surface of the lithium metal.

18. The apparatus of claim 17, wherein the first energy pulse is an oxidation pulse and the second energy pulse is a reductive pulse.

19. The apparatus of claim 17, wherein the first energy pulse is an oxidation pulse and the second energy pulse is a reductive pulse.

20. The apparatus of claim 18, wherein the first energy pulse and the second energy pulse form a square wave.

21-32. (canceled)
